(19) United States
(12) Patent Application Publication
(10) Pub. No.: US 2007/0098518 A1
(43) Pub. Date: May 3, 2007

(54) Expansion anchor

(76) Inventor: Falk Rosenkranz, Wildhaus (CH)

Correspondence Address: ABELMAN, FRAYNE & SCHWAB, 666 THIRD AVENUE, 10TH FLOOR, NEW YORK, NY, 10017, US

(21) Appl. No.: 11/591,990

(22) Filed: Nov. 1, 2006

(30) Foreign Application Priority Data
Nov. 3, 2005 (DE) 10 2005 000 148.3

(51) Int. Cl. F16B 13/06

(52) U.S. Cl. 411/60.2

(57) ABSTRACT

An expansion anchor includes a load application element (16) provided on the stem (12; 32; 42; 52; 62) and extending up to first end (14; 34; 44; 54; 64) of the stem, an anchoring mechanism (21; 36; 46; 56; 66) provided on the stem (12; 32; 42; 52; 62) and a seal (26; 37; 47; 57; 67) arranged between the anchoring mechanism (21; 36; 46; 56; 66) and the first end (14; 34; 44; 54; 64) of the stem (12; 32; 42; 52; 62) and having over its axial extent along a longitudinal axis (13) of the stem (12; 32; 42; 52; 62) different radial dimensions.

### BACKGROUND OF THE INVENTION

1. Field of the Invention

The present invention relates to an expansion anchor which is to be anchored in a borehole and which has a stem having a first end and a second end opposite the first end, load application means provided on the stem and extending up to first end, and an anchoring mechanism provided on the stem.

2. Description of the Prior Art

German Publication DE 195 41 564 A1 discloses an expansion anchor which is to be anchored in a borehole and which includes a stem having a first and a second end opposite the first end. On the stem, there is provided load application means extending up to the first end. For forming an anchoring mechanism, there are provided, on the stem, an expansion body that widens toward the second end and an expansion sleeve that at least partially surrounds the expansion body and is expandable hereby.

Such expansion anchors are used for securing a constructional part to a constructional component formed, e.g., of concrete, with the expansion anchors being preferably, percussively driven in a preliminary formed borehole. The load application means is preferably formed, e.g., as an outer thread on which a nut is screwed. For anchoring the expansion anchor in the borehole, the nut is screwed over the thread until it is supported against the to-be-secured part. With the nut being rotated, the stem, together with the expansion body, are displaced axially, and the expansion body expands, whereby the expansion sleeve is pressed against the borehole wall. Such expansion anchors are set simply and reliably and are economically produced. Therefore, they proved themselves in practice.

The drawback of the known expansion anchor consists in that media, e.g., water can penetrate in a gap between the expansion anchor and the borehole wall unhindered, which leads to a corrosion damage of the expansion anchor and, thus, to the reduction of its bearing capacity. In addition, the corrosion damage can affect the concrete reinforcement that was cut during formation of the borehole, which can lead to the reduction of the bearing capacity of the entire construction.

German Publication DE 10 204 591 A1 discloses an expansion anchor with a filling channel through which after the anchor has been anchored in the borehole, mortar mass is introduced into the borehole. The mortar mass can exit through an exit opening in a hole disc, which makes possible to control whether a complete filling of the gap in the borehole took place. The gap is, thus, sealed against penetration of media.

The drawback of the known solution consists in that several components need be handled, and many steps are necessary for anchoring the anchor. In addition, for as complete as possible hardening of the mortar, certain environmental conditions, e.g., temperature or humidity are necessary, which do not always exist. Further, when mortar is used, in most cases, adherence to particular operational measures is required, which increases operational expenses associated with anchoring of an expansion anchor. Still further, the storage life of the mortar or at least some of its separate components is limited. The use of resins instead of mortar for filling the gap between the expansion anchor and the borehole wall, results essentially in the same drawbacks as with using the mortar.

Accordingly, an object of the invention is to provide an expansion anchor that can be easily set in and with which a perfect sealing of the gap between the set anchor and the borehole wall is insured, without the above-mentioned drawbacks.

### SUMMARY OF THE INVENTION

This and other objects of the present invention, which will become apparent hereinafter, are achieved by providing an expansion anchor including a stem having a first end and a second end opposite the first end. On the stem, there is provided load application means which extends up to first end. On the stem, there is further provided an anchoring mechanism for anchoring the expansion anchor in a borehole. A seal is arranged between the anchoring mechanism and the first end of the stem. The seal has, over its axial extent along a longitudinal axis of the stem, different radial dimensions.

The maximal radial dimension or the maximal outer diameter of the seal, which is circumferentially arranged on the stem, is advantageously so formed that it is greater than the inner diameter of a borehole in which the expansion anchor is to be set. The seal forms a sheath that at least partially surrounds the stem. The expansion anchor is percussively driven in, e.g., with a hammer, in a preliminary formed bore, whereby at least the region of the seal adjacent to the first end engages a region of the borehole wall, completely sealing thereby the gap between the expansion anchor and the borehole wall. Advantageously, the seal is aggressive medium-resistant.

The expansion anchor has an integrated sealing function. For setting the inventive expansion anchor, the number of operational steps is comparable with setting of a conventional expansion anchor without a seal, so that the inventive anchor can be used almost without any limitations. The demands to the environmental conditions of the site are substantially lower than with sealing with mortar or resin, which substantially increases the application region of the inventive expansion anchor. An important advantage of the inventive expansion anchor also consists in that no specific operational measures are required with the use of the expansion anchor. In addition, the expansion anchor can be used without any problems at an overhead work. Overall, it can be concluded that the inventive expansion anchor can be handled and set substantially easier than a conventional expansion anchor, and it can be economically produced.

Preferably, the seal is formed as a coating which in order to form a one-piece part, is put on the stem in material-locking manner at a manufacturing plant. E.g., the coating is formed using a polymer-coating process, or a corresponding anchor region is sheathed with a plastic layer in an injection-molding process.

Advantageously, the seal has, with reference to the longitudinal axis, an increased radial dimension in a direction of the first end. In this embodiment, the seal has at least one section having a shape of a wedge or cone that widens in a direction opposite the setting direction of the expansion anchor. This provides for an easy driving of the inventive expansion anchor in.

Advantageously, the seal is formed as a succession of a plurality of truncated cones having their larger base surfaces located closer to the first end of the stem. This advantageous embodiment of the inventive expansion anchor has not only more sealing regions distributed over the axial extent of the seal but also a very robust construction. The percussive driving of the expansion anchor in a constructional component will be hindered by so-formed seal only to a non-significant extent.

Advantageously, the seal has a plurality of radially extending, circumferentially arranged elevations, whereby a plurality of sealing points are available along the axial extent in the direction of the longitudinal axis of the expansion anchor. Because the contact surface between the seal and the borehole wall is reduced to a plurality of separate regions, the inventive expansion anchor is easily driven in. The elevations are formed, e.g., as radially extending circumferential ribs or lamellas with a polygonal cross-section. Alternatively, the elevations can have a lip-shaped profile, with the free end of the elevations advantageously facing toward the first end of the stem. According to another embodiment, the seal can have a plurality of radially extending circumferential elevations having different profiles.

Preferably, the seal is formed of a strip wound about the stem of the expansion anchor and having a wedge-shaped cross-section. The strip is wound one or several times about the stem, starting with the smaller edge region, in a region between the anchoring mechanism and the first-end of the stem, forming a cone-shaped seal of the expansion anchor. The expansion anchor is provided with the strip seal either during its manufacturing at the plant or on the construction site. Advantageously, the strip has a glue layer which, on one hand, insures adhesion of the strip to the stem and, on the other hand, insures adhesion of the strip to itself, when necessary. The strip with a glue layer is put on the stem as an adhesive tape. The glue layer is advantageously provided with a removable cover foil. The strip can be arranged on the stem of the expansion anchor at the manufacturing plant or be shipped to the user as a separate component for a subsequent arrangement on the stem. Possible gaps, which may be formed upon winding of the strip, e.g., at the strip end, are compressed upon setting of the anchor, so that no loss of tightness occurs with a set expansion anchor.

This embodiment of the inventive expansion anchor is advantageous, e.g., for anchoring the expansion anchor in constructional components which because of their material characteristics, has a tendency to form break-outs in the region of the borehole during formation of the borehole. The sealing function of the expansion anchor can be easily varied with this embodiment. With a corresponding number of strip windings, a necessary or a desired radial dimension of the seal for a satisfactory sealing of the gap between the expansion anchor and the borehole wall can be easily obtained.

The storage life of this embodiment of the expansion anchor is limited to a certain extent because of the properties of the glue coating of the strip. However, the storage life of this expansion anchor is still substantially greater than the storage life of a mortar or resin system. Also, in this embodiment, no age hardening of the seal occurs. Likewise, environmental conditions at the construction site should meet only very low demands, which substantially increase the application region of the inventive expansion anchor, and no specific operational measures need be undertaken. This embodiment of the expansion anchor likewise can be used in overhead work without any problems.

Advantageously, the seal is formed of a deformable material which, advantageously, is weaker than the material of the constructional component the expansion anchor is to be anchored, and weaker than the steel the expansion anchor is formed of. As a result of the use of the deformable material, the seal is deformed, when the expansion anchor is driven in, and is pressed against the borehole wall.

Advantageously, the seal includes elastically deformable components which provide for a perfect sealing of the gap between the expansion anchor and the borehole wall even at a non-uniform shape of the borehole wall.

In addition, the elastically deformable components of the seal can compensate possible, thermally induced, dimensional changes of the seal. Advantageously, the seal has, in addition to the elastically deformable components also plastically deformable components.

Advantageously, the seal is formed of a thermoplastically treatable material such as, e.g., thermoplast, thermoplastic elastomer, or of elastomer-like thermoplasts. These materials are characterized by economical processing, using established methods such as, e.g., whirl sintering or injection-molding, and by their small price. In addition, many of these materials are resistant to media relevant to building materials, and are available practically with each desired hardness. PE (polyethylene), PA (polyamide), POM (poly-oxymethylene), PP (polypropylene), EVA (ethylenevinylacetate), TPU (thermoplastic polyurethane), TPA (thermoplastic polyamidelastomer), TEEE (polyetheresterelastomer), TPS (SEBS: styrolethylenebuthylenstyrole), or TPV (cross-linked elastomer in a thermoplastic matrix) are examples of such materials. However, these examples are not limiting.

Alternatively, the seal can be formed of a cross-linked elastomer. These materials have a high thermal resistance and a high media-resistance, in particular in comparison with thermoplastic elastomers. Further, the cross-linked elastomers have a smaller tendency to creeping and relaxation than thermoplastic elastomers. Also, the cross-linked elastomers are characterized by their low price.

An example of a possible cross-linked elastomer is EPDM (ethylene-propylene-dien-resin).

According to another alternative embodiment, the seal is formed of metal or alloy which, advantageously, are deformed during setting of the anchor.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS:

The drawings show:

FIG. 1 a longitudinal cross-sectional view of a first embodiment of an expansion anchor according to the present invention in a set condition;

FIG. 2 a side view of the expansion anchor according to FIG. 1;

FIG. 3 a side view of a second embodiment of an expansion anchor according to the present invention;

FIG. 4 a longitudinal cross-sectional view of a third embodiment of an expansion anchor according to the present invention in a set condition;

FIG. 5 a side view of a fourth embodiment of an expansion anchor according to the present invention;

FIG. 6 a perspective view of a fifth embodiment of an expansion anchor according to the present invention; and

FIG. 7 a longitudinal cross-sectional view of a strip for the expansion anchor according to FIG. 6.

In the drawings identical elements are designated with the same reference numerals.

### DETAILED DESCRIPTION OF THE PREFERRED EMBODIMENTS

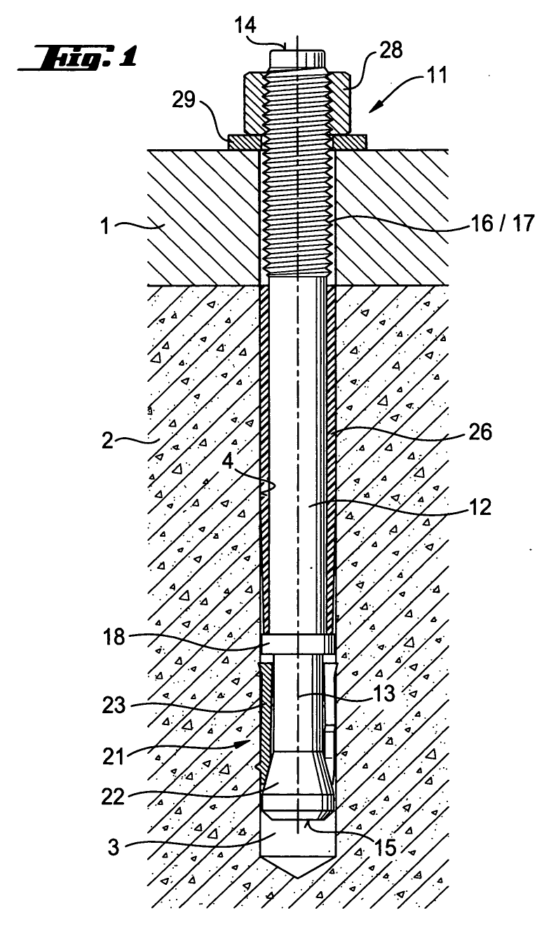

An expansion anchor 11 according to the present invention, a first embodiment of which is shown in FIGS. 1-2, has a stem 12, a first end 14, and a second end 15 located opposite the first end 14.

On the stem 12, there is provided an outer thread 17 that extends up to the first end 14 and forms load application means 16. For forming an anchoring mechanism 21, there are provided, on the stem 12, an expansion body 22 that widens toward the second end 15, and an expansion sleeve 23 that at least partially surrounds the expansion body 22 and is expandable thereby.

The expansion anchor 11 further includes a seal 26 located between the anchoring mechanism 21 and the first end 14 of the stem 12. The seal 26 is formed as a coating and has a different radial extent over its axial extent along an axis 13 of the stem 12. The sealing 26 has, in a direction of the first end 14 along the longitudinal axis 13 of the stem 12, a radially increasing dimension. The seal 26 is formed of a deformable, thermoplastically treatable material having elastic and, advantageously, plastically deformable components.

For securing a constructional part 1 on a constructional component 2 such as, e.g., concrete floor, in a first step, a borehole 3 is formed in the constructional component 2. Then, the expansion anchor 11 is driven in the borehole 3 with a hammer, with the seal 26 abutting, at least regionwise, the borehole wall 4. For anchoring the expansion anchor 11 in the borehole 3, a nut 28 with a washer 29 are arranged on the outer thread 17, with the nut 28 tightening the expansion anchor 11 upon rotation. The nut 28 is supported on the constructional component 1 by the washer 29, with the stem 12 being displaced in the axial direction. The displaceable stem 12 causes the expansion body 22 to expand the expansion sleeve 23 which becomes pressed against the borehole wall 4. On the stem 12, there is provided a circumferential stop 18 for the expansion sleeve 23 and which limits the displacement of the expansion sleeve 23 in the direction of the first end 14 and parallel to the longitudinal axis 13 upon sinking of the stem 12 in.

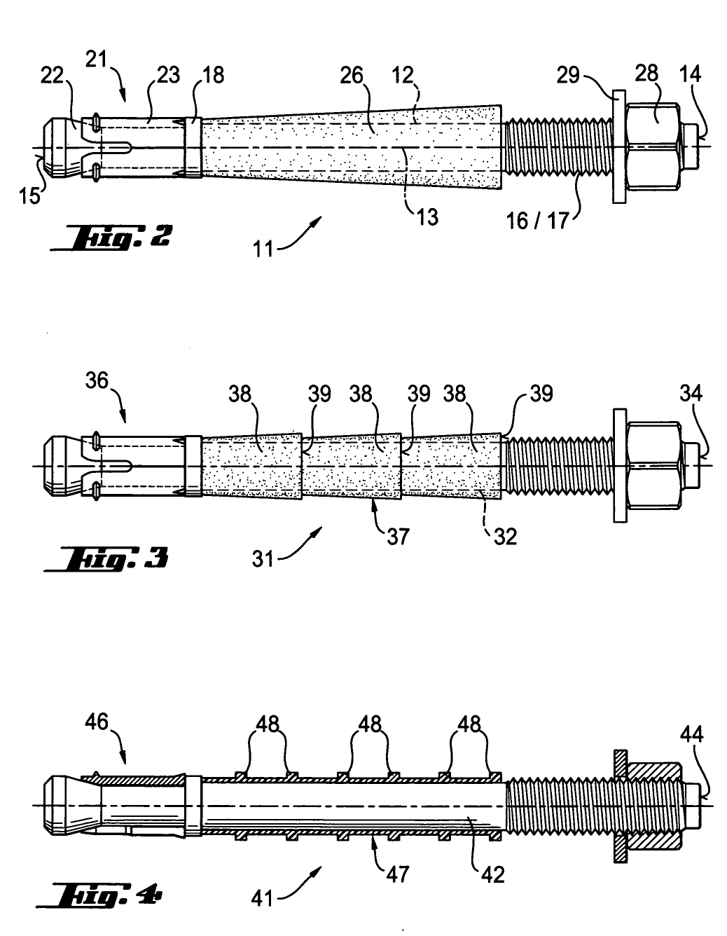

An expansion anchor 31, which is shown in FIG. 3, has, between the anchoring mechanism 36 and the first end 34 of the stem 32, a seal 37 in form of coating and which is formed as a succession of several truncated cones 38, with their larger base surface 39 located closer to the first end 34 of the stem 32. The seal 37 is formed of a cross-linked elastomer.

An expansion anchor 41, which is shown in FIG. 4, has, between the anchoring mechanism 6 and the first end 44 of the stem 42, a seal 47 in form of a coating and having a plurality of radially arranged ribs having a rectangular cross-section and forming elevations 48.

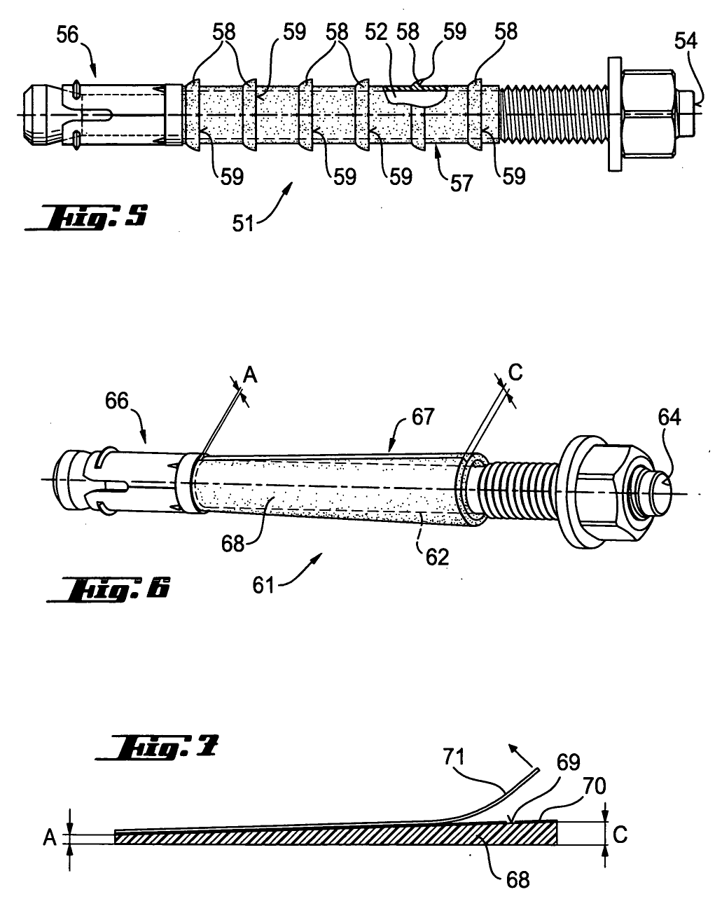

An expansion anchor 51, which is shown in FIG. 5, has a seal 57 in form of a coating and arranged between the anchoring mechanism 56 and the first end 54 of the stem 52. The seal 57 forms radially, circumferentially arranged elevations 58. The elevations 58 are lip-shaped and have their free ends 59 located closer to the first end 54 of the stem 52.

An expansion anchor 61, which is shown in FIG. 6-7, also has a stem 62 on which there is arranged a seal 67 formed of a strip 68 wound about the stem 62. The seal 67 is located between the anchoring mechanism 66 and the first end 64 of the stem 62. The strip 68 has a wedge-shaped cross-section with a first thickness A and a second thickness C that is greater than the thickness A.

On one side 69, the strip 68 is coated with glue 70 which is covered with a cover foil 71 that is removed before arrangement of the strip 68 on the stem 62.

The smaller edge region, which has the first thickness A, is located above the anchoring mechanism 66, and the strip 68 is wound about the stem 68 several times and is spaced from the first end 64, whereby a cone-shaped seal 67 of the expansion anchor is formed.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. An expansion anchor, comprising a stem (12; 32; 42; 52; 62) having a first end (14; 34; 44; 54; 64) and a second end (15) opposite the first end (14; 34; 44; 54; 64); load application means (16) provided on the stem (12; 32; 42; 52; 62) and extending up to first end (14; 34; 44; 54; 64); an anchoring mechanism (21; 36; 46; 56; 66) provided on the stem (12; 32; 42; 52; 62); and a seal (26; 37; 47; 57; 67) arranged between the anchoring mechanism (21; 36; 46; 56; 66) and the first end (14; 34; 44; 54; 64) of the stem (12; 32; 42; 52; 62) and having over an axial extent thereof along a longitudinal axis (13) of the stem (12; 32; 42; 52; 62) different radial dimensions.

2. An expansion anchor according to claim 1, wherein the seal (26; 37; 67) is formed as a coating.

3. An expansion anchor according to claim 1, wherein the seal (26; 37; 67) has, with reference to the longitudinal axis (13), an increased radial dimension in a direction of the first end (14; 34; 64).

4. An expansion anchor according to claim 1, wherein the seal (37) is formed as a succession of a plurality of truncated cones (38) having their larger base surface (39) located closer to the first end (34) of the stem (32)

5. An expansion anchor according to claim 1, wherein the seal (47; 57) has a plurality of radial, circumferentially arranged elevations (48, 58).

6. An expansion anchor according to claim 1, wherein the seal (67) is formed of a strip (68) wound about the stem (62) of the expansion anchor (61) and having a wedge-shaped cross-section.

7. An expansion anchor according to claim 1, wherein the seal (26; 37; 47; 57; 67) is formed of a deformable material.

8. An expansion anchor according to claim 7, wherein the seal (26; 37; 47; 57; 67) has elastically deformable components.

9. An expansion anchor according to claim 8, wherein the elastically deformable components are plastically deformable.

10. An expansion anchor according to claim 1, wherein the seal (26) is formed of a thermoplastically treatable material.

11. An expansion sleeve according to claim 1, wherein the seal (37) is formed of a cross-linked elastomer.
